(19) United States
(12) Patent Application Publication
(10) Pub. No.: US 2026/0214607 A1
(43) Pub. Date: Jul. 23, 2026

(54) SERVICE CLUSTER UPDATE

(71) Applicant: Nokia Technologies Oy, Espoo (FI)

(72) Inventors: Xin ZHANG, Munich (DE); Tao YANG, Shanghai (CN); Rakash SIVASIVA GANESAN, Munich (DE); Pingping WEN, Shanghai (CN)

(21) Appl. No.: 19/137,749

(22) PCT Filed: Jan. 31, 2023
(86) PCT No.: PCT/CN2023/074005

§ 371 Date: Jun. 11, 2025

(51) Int. Cl. H04W 56/00

(52) U.S. Cl. CPC H04W 56/0045

(57) ABSTRACT

Devices, methods, apparatuses and computer readable storage media of service cluster update are disclosed. The method comprises selecting, by a distributed network node and from a set of candidate transmission and reception points, TRPs, one or more target TRPs associated with an update of a service cluster of a terminal device at least based on timing advances of the terminal device respect to the set of candidate TRPs; and transmitting information related to the update of a service cluster.

### FIELD

Embodiments of the present disclosure generally relate to the field of telecommunication and in particular to devices, methods, apparatuses and computer readable storage media of service cluster update.

### BACKGROUND

The main objectives for the Multiple Input Multiple Output (MIMO) enhancement may involve beam management, multiple transmission and reception point (mTRP) for ultra-reliable, low-latency communication (URLLC), mTRP for enhanced mobile broadband (eMBB) and Time Division Duplexing (TDD)/Frequency Division Duplexing (FDD) reciprocity.

The mTRP enhancements for eMBB increase robustness for the physical downlink control channel (PDCCH), physical uplink shared channel (PUSCH) and physical uplink control channel (PUCCH). They also enable richer channel state information (CSI) feedback for non-coherent joint transmission (NC-JT) and optimize performance for high-speed-train (HST) communication scenarios.

### SUMMARY

In general, example embodiments of the present disclosure provide a solution of service cluster update.

In a first aspect, there is provided a distributed network device. The distributed network device comprises at least one processor; and at least one memory storing instructions that, when executed by the at least one processor, cause the distributed network device at least to perform: selecting, from a set of candidate TRPs, one or more target TRPs associated with an update of a service cluster of a terminal device at least based on timing advances of the terminal device respect to the set of candidate TRPs; and transmit information related to the update of a service cluster.

In a second aspect, there is provided a TRP. The TRP comprises at least one processor; and at least one memory storing instructions that, when executed by the at least one processor, cause the TRP at least to perform: receiving, from a distributed network node, information related to an update of a service cluster of a terminal device.

In a third aspect, there is provided a TRP. The TRP comprises at least one processor; and at least one memory storing instructions that, when executed by the at least one processor, cause the TRP at least to perform: determining a timing advance of a terminal device respect to the TRP based on an uplink resource allocation for the terminal device and an uplink signal received from the terminal device; and transmitting information about the timing advance to a distributed network node.

In a fourth aspect, there is provided a terminal device. The terminal device comprises at least one processor; and at least one memory storing instructions that, when executed by the at least one processor, cause the terminal device at least to perform: receiving, from a distributed network device, an indication of an uplink resource allocation for the terminal device; and transmitting an uplink signal to a set of candidate TRPs.

In a fifth aspect, there is provide a method. The method comprises selecting, by distributed network node and a from a set of TRPs, one or more target TRPs associated with an update of a service cluster of a terminal device at least based on timing advances of the terminal device respect to the set of candidate TRPs; and transmitting information related to the update of a service cluster.

In a sixth aspect, there is provide a method. The method comprises receiving, at a TRP and from a distributed network node, information related to one or more target TRPs associated with an update of a service cluster of a terminal device.

In a seventh aspect, there is provided a method. The method comprises determining, at a TRP, a timing advance of a terminal device respect to the TRP based on an uplink resource allocation for the terminal device and an uplink signal received from the terminal device; and transmitting information about the timing advance to a distributed network node.

In an eighth aspect, there is provided a method. The method comprises receiving, at a terminal device and from a distributed network device, an indication of an uplink resource allocation for the terminal device; and transmitting an uplink signal to a set of TRPs.

In a ninth aspect, there is provided an apparatus comprising means for selecting, from a set of candidate TRPs, one or more target TRPs associated with an update of a service cluster of a terminal device at least based on timing advances of the terminal device respect to the set of candidate TRPs; and means for transmitting information related to the update of a service cluster.

In a tenth aspect, there is provided an apparatus comprising means for receiving, from a distributed network node, information related to one or more apparatuses associated with an update of a service cluster of a terminal device.

In an eleventh aspect, there is provided an apparatus comprising means for determining a timing advance of a terminal device respect to the apparatus based on an uplink resource allocation for the terminal device and an uplink signal received from the terminal device; and means for transmitting information about the timing advance to a distributed network node.

In a twelfth aspect, there is provided an apparatus comprising means for receiving, from a distributed network device, an indication of an uplink resource allocation for the apparatus; and means for transmitting an uplink signal to a set of candidate TRPs.

In a thirteenth aspect, there is provided a computer readable medium having a computer program stored thereon which, when executed by at least one processor of an apparatus, causes the apparatus to carry out the method according to the fifth aspect, the sixth aspect, the seventh aspect or the eighth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart of a process of service cluster update according to some example embodiments of the present disclosure;

FIG. 3 shows a signaling chart of a process of service cluster update according to some example embodiments of the present disclosure;

FIG. 4 shows a signaling chart of a process of service cluster update according to some example embodiments of the present disclosure;

FIG. 5 shows a flowchart of an example method of service cluster update according to some example embodiments of the present disclosure;

FIG. 6 shows a flowchart of an example method of service cluster update according to some example embodiments of the present disclosure;

FIG. 7 shows a flowchart of an example method of service cluster update according to some example embodiments of the present disclosure;

FIG. 8 shows a flowchart of an example method of service cluster update according to some example embodiments of the present disclosure;

FIG. 9 shows a simplified block diagram of a device that is suitable for implementing example embodiments of the present disclosure; and

FIG. 10 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT), an Enhanced Machinetype communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the terms “network device”, “radio network device” and/or “radio access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, the radio access network (RAN) split architecture includes a Centralized Unit (CU) and a Distributed Unit (DU). In some other example embodiments, part of the radio access network device or full of the radio access network device may embarked on an airborne or space-borne NTN vehicle.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

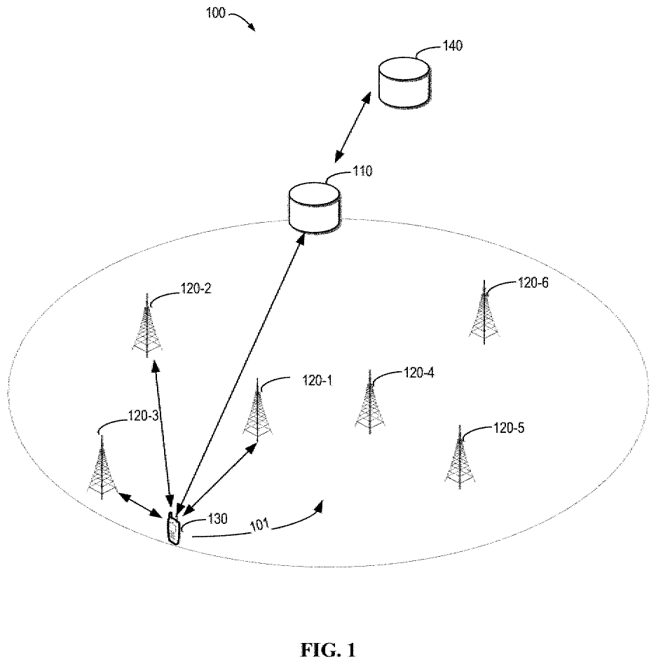

FIG. 1 shows an example communication network 100 in which embodiments of the present disclosure may be implemented. As shown in FIG. 1, the communication network 100 may comprise a distributed network device 110 (hereinafter may also be referred to as a DU), which may manage a plurality of TRPs namely TRPs 120-1 to 120-6. The TRPs 120-1 to 120-6 (hereinafter may also be referred to a TRP 120 collectively) may communicate with the distributed network device 110, respectively. As described above, the RAN split architecture may include a CU and a DU. The DU 140 may communicate with a CU 150. The terms “TRP” used herein may be referred to as a network device and more specifically to as a macro-cell, a small cell, a pico-cell, a femto-cell, a remote radio head, a relay node, etc.

The communication network 100 may comprise a terminal device 130 (hereinafter may also be referred to as a UE). Some TRPs in the plurality of TRPs namely TRPs 120-1 to 120-6 under the DU 110 may serve the terminal device 130. For example, the TRPs 120-1 to 120-3 now serving the terminal device 130 may form a service cluster of the terminal device 130.

As the movement of the terminal device 130 (for example, along the direction 101), the service cluster may be changed. For example, in a case where the terminal device 110 moves away from the TRPs 120-2 and 120-3, and moves towards TRPs 120-4 and 120-5, the service cluster of the terminal device 130 may involve TRP 120-1, 120-4 and 120-5 after an update of the service cluster.

It is to be understood that the number of terminal devices and network devices shown in FIG. 1 is given for the purpose of illustration without suggesting any limitations. The communication network 100 may include any suitable number of terminal devices and network devices.

Furthermore, it is to be understood that a service cluster of the terminal device 130 may include more or less than 3 TRPs. The number of TRPs included in the service cluster (i.e., how many simultaneous connections the terminal device can have with TRPs) may depend on the capability of the terminal device 130.

As describe above, the mTRP enhancement has been discussed and developed. The mTRP enhancement may allow the UE to receive control information and data from multiple TRPs. However, in non-coherent joint transmission, the UE may process the data/control information from each TRP individually at different time frame. Now the 3GPP is moving towards coherent joint transmission (CJT). With the coherent transmission, the UE may see only a single link from multiple TRPs. It coherently combined the Signal-Noise Ratio (SNR) of signal. At the network side, in coherent transmission, the signal has to be transmitted in phase alignment among different TRPs. This may provide better performance when the radio link is weak.

The scenarios of inter-cell mTRP may involve the case when the cells are from the same DU or the case when the cells are from different DUs/CUs/nodes. In a case where the cells are not from the same DU, the setup of an assisting TRP may be performed. Specifically, based on UE Layer 3(L3) measurement reports, the source node controlling a source cell identifies a potential assisting cell controlled by different DU/node and proceeds in sending a “TRP Addition Request” for an assisting cell. Upon receiving the response in “TRP Addition Request ACK message”, it sends a Radio Resource Control (RRC) Reconfiguration to the UE with the respective configuration of the assisting cell (TRP). When the source node decides on mTRP activation due to some reasons such as heavy traffic load, it will send a MAC-CE mTRP activation to UE. Then the UE proceeds in random access to the assisting cell and start the data transmission to multiple TRPs.

Furthermore, the inter-cell mTRP procedure can be made to operate with and without handover (HO) of the serving cell. Specifically, the source node initially sets up the mTRP operation (serving and assisting cells) and then based on the measurement report, it identifies a handover target cell and sends a handover request and receives the corresponding response. Then, the source node forwards the RRC Reconfiguration (HO Command) to the UE and informs the assisting node (controlling the assisting cell) about the release of the mTRP. Upon receiving the RRC Reconfiguration containing the handover command, the UE performs the HO and once it is completed, the UE may provide the required measurements to the target node which may configure the inter-cell mTRP and add the same assisting cell that was configured by the source cell previously before the handover.

As described above, it is up to UE's capability about how many simultaneous connections it can have with TRPs. Assuming that a UE can support up to three simultaneous TRP connections, the UE may change several times the TRPs it stays connected with even within the same cell due to the higher density of TRPs in 6G.

Regardless of lower layer or higher layer mobility with mTRP, the HO command is triggered at the CU level based on L3 measurements in a mTRP handover procedure in 5G. However, the L3 measurements are not up-to-date enough for high speed scenario and CU-level triggered significantly slow down the procedure.

Furthermore, the handover procedure in 5G mobility is “breaks before make”. That is, the connection between the UE and a TRP may be broken before another connection between the UE and a new TRP is established.

Therefore, how to handle mobility seamlessly in 6G deployed with a higher density of TRPs may need to be further discussed. First, an interesting aspect in the intra-cell scenario that need to be discussed is how to update the serving TRP cluster.

The solution of the present disclosure proposes a service cluster update. In this solution, the distributed network device 110 selects, from a set of candidate TRPs, one or more target TRPs associated with an update of a service cluster of a terminal device at least based on timing advances of the terminal device respect to the set of candidate TRPs and transmit information related to the update of a service cluster.

Example embodiments of the present disclosure will be described in detail below with reference to the accompanying drawings.

Before serving a terminal device 130, the distributed network device 110 may assigns different reference signal (such as Channel State Information Reference Signal (CSI-RS)) to different TRPs and broadcast to the terminal device 130 by DL Physical Broadcast Channel (PBCH) or by DL PDSCH, so that the terminal device 130 may measure and feedback the DL channel information of the corresponding TRPs and DL PDSCH may be used to indicate the resource to trigger CFRA transmission later.

Furthermore, DU may reserve an amount of common Physical Random Access Channel (PRACH) resource for relevant TRPs connecting to itself, which is used for the terminal device to perform a UL synchronization procedure with multiple TRPs simultaneously with one UL PRACH transmission procedure.

During the normal data transmission of the terminal device 130, the distributed network device 110 may trigger the terminal device 130 for its channel measurement for TRPs that are on its current serving cluster (for example, the TRPs 120-1 to 120-3 as shown in FIG. 1) and also for other relevant TRPs such as those neighbouring TRPs to its current serving cluster (for example, the TRPs 120-4 to 120-6 as shown in FIG. 1). The relevant TRPs may comprise TRPs outside the service cluster of the terminal device 130, e.g., requested by network, or by visibility.

After that, the terminal device 130 may send the best K channel measurement reports to the distributed network device 110 from either periodic, semi-persistent, aperiodic or event trigger. The distributed network device 110 may decide maximum up to K TRPs which may receive the common UL resources from terminal device 130 and estimate a Timing Advance (TA). These TRPs may form the measurement cluster.

For example, as shown in FIG. 1, the TRPs 120-1 to 120-3 are included in a current service cluster of the terminal device 130. As the movement of the terminal device 130, the service cluster of the terminal device 130 may be changed. After the channel measurement, the distributed network device 110 may chose, from the TRPs 120-1 to 120-6, a set of TRPs to form a measurement cluster. For example, the TRP 120-1, 120-4, 120-5 and 120-6 are selected to form the measurement cluster. Hereafter the TRPs and 120-6 in the measurement cluster may also be referred to as a set of candidate TRPs 120-1, 120-4, 120-5 and 120-6. The distributed network device 110 may select one or more TRPs from the set of candidate TRPs 120-1, 120-4, 120-5 and 120-6, to form an updated service cluster. Hereinafter the TRPs forming the updated service cluster may be referred to as the target TRPs.

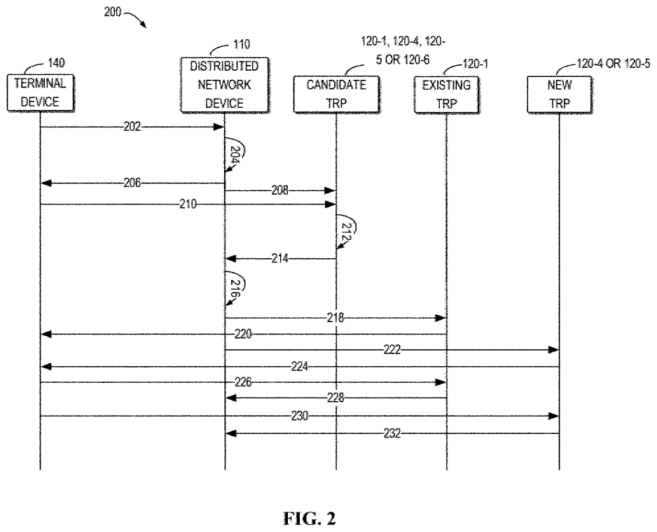

Reference is now made to FIG. 2, which shows a signaling chart 200 for communication according to some example embodiments of the present disclosure. As shown in FIG. 2, the signaling chart 200 involves a distributed network device 110, a terminal device 130 and a candidate TRP 120-1, 120-4, 120-5 or 120-6, a TRP of the updated service cluster that is already in a previous service cluster 120-1 and a TRP new joined to the updated service cluster 120-4 or 120-5. For the purpose of discussion, reference is made to FIG. 1 to describe the signaling chart 200.

As shown in FIG. 2, the terminal device 130 may transmit 202, to the distributed network device, a channel measurement report of the terminal device 130. Then the distributed network device 110 may select 204 a set of candidate sets to form a measurement cluster.

The distributed network device 110 may inform 206 the terminal device 130 about the UL resources in time and/or frequency domain and the Contention Free Random Access (CFAR) preamble. The distributed network device 110 may also inform 208 the candidate TRP 120-1, 120-4, 120-5 or 120-6 about the UL resource in time and/or frequency domain and the CFRA preamble allocated for the terminal device 130.

Then the terminal device 130 may transmit 210, to the candidate TRP 120-1, 120-4, 120-5 or 120-6, at least one of a random access message (for example, Message 1), a Sounding Reference Signal (SRS) or a resource in the scheduled time and frequency resources.

Then each of the candidate TRP 120-1, 120-4, 120-5 or 120-6 may estimate 212 the TA of the terminal device 130 respective to itself. The candidate TRP 120-1, 120-4, 120-5 or 120-6 may transmit 214, to the distributed network device 110, its respective TA information of the terminal device 130. Based on the received TA information, the distributed network device 110 may select 216 one or more TRPs from the measurement cluster to form the updated serving cluster. The s one or more TRPs may send data/control information to UE simultaneously. The selected TRP(s) for the updated serving cluster may also be referred to as target TRP(s) hereinafter.

In some example embodiments, the distributed network device 110 may select the target TRP(s) from the candidate TRPs 120-1, 120-4, 120-5 and 120-6 based on the TA information and some other rules.

For example, if a candidate TRP's TA measurement is not aligned with a final determined TA value, the candidate TRP may not be selected as the target TRP. In some other example embodiments, if a radio link quality and/or a load of a candidate TRP do not satisfy a threshold level, the candidate TRP may not be selected as the target TRP. If the candidate TRP is an existing TRP in the previous service cluster, this candidate TRP may be removed from the updated service cluster.

By contrast, if a candidate TRP's TA measurement is aligned with a final determined TA value, the candidate TRP may be selected as the target TRP. Optionally or additionally, if a candidate TRP's TA measurement satisfies (for example, exceeds) a pre-defined threshold, the candidate TRP may be selected as the target TRP. Alternatively, if a candidate TRP's TA measurement is above that of an existing service cluster by a threshold value, the candidate TRP may be selected as the target TRP. For example, if a TA measurement of a new TRP is above that of a previous service cluster by a threshold value, the new TRP may be added to the update service cluster.

That is, the one or more target TRP for forming the updated service cluster of the terminal device 130 may comprise one or more existing TRPs that are already in the service cluster previously and one or more new TRPs new joined to the update service cluster.

For example, in the process 200, the TRP 120-1 may be selected as a target TRP for forming the update service cluster, which is an existing TRP that is already in the service cluster previously. The TRPs 120-4 and 120-5 may also be selected as target TRPs, which are new joined to the update service cluster.

After the target TRPs are determined, as an option, the distributed network device 110 may transmit 218, to the TRP 120-1 (may also be referred to as an existing TRP in the updated service cluster), an activation command about the new RRC configuration of the new TRPs 120-4 and 120-5.

As another option, the distributed network device 110 may transmit 222, to the TRP 120-4 or TRP 120-5 (may also be referred to as new TRPs in the updated service cluster), an activation command about the new RRC configuration of the new TRPs 120-4 and 120-5.

The activation command may comprise the frequency and time resource for terminal device 130 to send the Medium Access Control-Control Element (MAC-CE) request later. Optionally or additionally, a TA value may also be included in this activation command. If this field is not present, the terminal device 130 may use ta legacy TA, while if this field is present with a new TA value, the terminal device 130 may apply this TA to all TRPs in the serving cluster. In this step, the distributed network device 110 may schedule the resources for different physical (PHY) layer technique and indicate the TRP(s) that may update the distributed network device for TRP modification via MAC-CE.

For the scenario in a distributed MIMO (dMIMO), the resources are known and common to all TRPs in the serving cluster. The distributed network device 110 may use one-bit indication to indicate if the new TRP 120-4 or 120-5 will inform the distributed network device 110 about the update or the existing TRP 120-1 will inform the distributed network device 110 about the update.

For the scenarios in the NC-JT or CJT, if the distributed network device 110 would like to receive update from existing TRP, the distributed network device 110 may schedule the resources for receiving MAC-CE update only visible to existing TRP 120-1, otherwise, to new TRP 120-4 or 120-5.

After receiving RRC configuration for activating the new TRP, the existing TRP 120-1 may send 220 an activation command to the terminal device 130 via existing connection or dynamic DL scheduling about the frequency and time resource of the MAC-CE command from the terminal device 130, as well as the TA value associate to this the terminal device 130 from each TRPs and the new TRP configuration.

Then the terminal device 130 may send 226 the TRP modification request ACK via MAC-CE to the existing TRP 120-1 in the service cluster in response to the request from action 220. Then the existing TRP 120-1 in the service cluster may send 228, to the distributed network device 110, a TRP modification update message to update the distributed network device 110.

After receiving RRC configuration for activating the new TRP, the new TRP 120-4 or 120-5 in the service cluster may send 224 an activation command to the terminal device 130 via pre-determined resources such as those in the action 210 about the frequency and time resource of the MAC-CE command from the terminal device 130, as well as the TA value associate to this the terminal device 130 from each TRPs and the new TRP configuration.

Then the terminal device 130 may send 230 the TRP modification request ACK via MAC-CE to the new TRP 120-4 or 120-5 in the service cluster in response to the request from action 224. Then the new TRP 120-4 or 120-5 in the service cluster may send 232, to the distributed network device 110, a TRP modification update message to update the distributed network device 110.

Reference is now made to FIG. 3, which shows a signaling chart 300 for communication according to some example embodiments of the present disclosure. As shown in FIG. 3, the signaling chart 300 involves a distributed network device 110, a terminal device 130 and a candidate TRP 120-1, 120-4, 120-5 or 120-6, a TRP 120-1 of the updated service cluster that is already in a previous service cluster and a TRP 120-4 or 120-5 new joined to the updated service cluster. For the purpose of discussion, reference is made to FIG. 1 to describe the signaling chart 300.

In the scenarios of FIG. 3, the TRP 120-1 may referred to as an Alpha TRP, which means the TRP 120-1 is allowed to transmit the control information in the existing serving cluster (before the update).

The process (actions 302 to 316) for forming the measurement cluster (the determination of the set of candidate TRPs) and the updated service cluster (the determination of one or more target TRPs) is similar with the scenario as described with respect to FIG. 2, which is omitted here.

After the determination of the one or more target TRPs, as an option, the distributed network device 110 may inform 318 the TRP 120-1 (considered as an Alpha TRP) about TRPs that require changes, for example, new TRP to request to join (e.g., TRP 120-4 or 120-5), and/or an old TRP (in the serving cluster before the update) to request to quit.

Then the TRP 120-1 may transmit 320 a TRP modification request to a new TRP 120-4 or 120-5. The TRP 120-4 or 120-5 may response 322 with a modification response to the TRP 120-1.

As another option, the distributed network device 110 may inform 324 TRPs that requires changes (for example, the new TRP 120-4 or 120-5) about TRPs that require changes, for example, new TRP to request to join (e.g., TRP 120-4 or 120-5), and/or an old TRP (in the serving cluster before the update) to request to quit and also the information of the Alpha TRP (for example the TRP 120-1). Then the TRP 120-4 or 120-5 may transmit 326 a TRP modification request to the TRP 120-1 and the TRP 120-1 may response 328 with a modification response to the TRP 120-4 or 120-5.

In this way, the distributed network device 110 may update this alpha TRP about the new TRP, and the alpha TRP may add the new TRP to the service cluster without involvement of the terminal device.

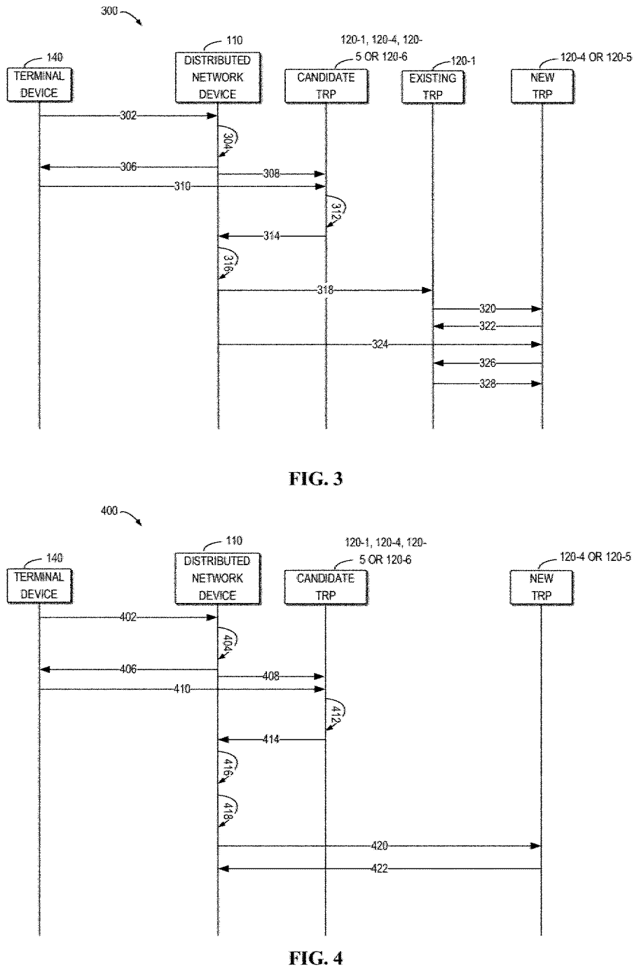

In some example embodiments, there may be no alpha TRP in the updated service cluster. Reference is now made to FIG. 4, which shows a signaling chart 400 for communication according to some example embodiments of the present disclosure. As shown in FIG. 4, the signaling chart 400 involves a distributed network device 110, a terminal device 130 and a candidate TRP 120-1, 120-4, 120-5 or 120-6, and a TRP 120-4 or 120-5 new joined to the updated service cluster. For the purpose of discussion, reference is made to FIG. 1 to describe the signaling chart 400.

The process (actions 402 to 416) for forming the measurement cluster (the determination of the set of candidate TRPs) and the updated service cluster (the determination of one or more target TRPs) is similar with the scenario as described with respect to FIG. 2, which is omitted here.

In some example embodiments, after the determination of the one or more target TRPs, the distributed network device 110 may update 418 the service cluster based on the one or more target TRPs.

Then the distributed network device 110 may transmit 420, to TRPs that requires changes (for example, the new TRP 120-4 or 120-5), a TRP modification request indicating TRPs that require changes, for example, new TRP to request to join (e.g., TRP 120-4 or 120-5), and/or an old TRP (in the serving cluster before the update) to request to quit. The TRP 120-4 or 120-5 may response 422 with TRP modification response to the distributed network device 110.

In this way, in a case where there is no alpha TRP, the distributed network device 110 may add the new TRP to the service cluster and notify the new TRP about the modification without involvement of the terminal device.

The solution of the present disclosure may be appliable to the scenarios of NCJT, CJT and dMIMO transmission at the PHY layer. In a case where the service cluster updates within the same cell, the PHY and MAC layer novelties in the proposed solution may be first noticed. However, the proposed solution may also form a basis for later development into more complicated scenarios such as moving across different cells, DU, or CU.

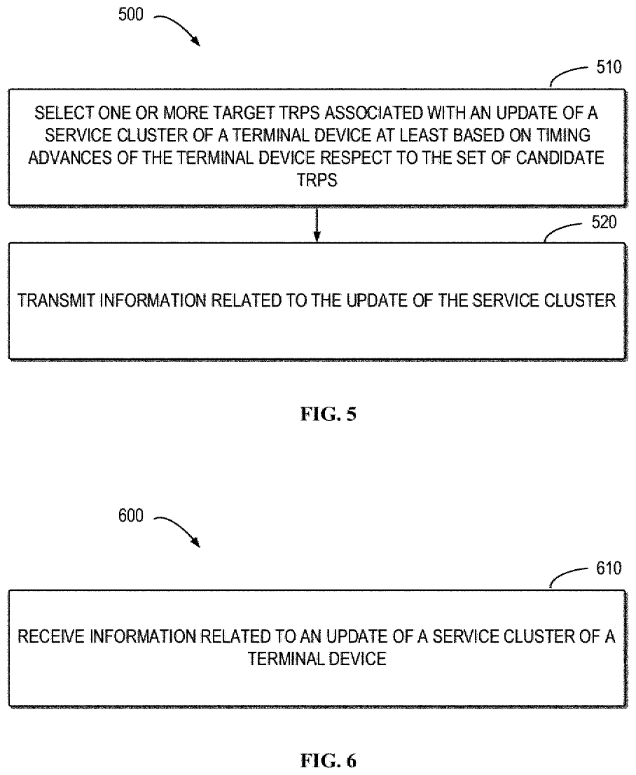

FIG. 5 shows a flowchart of an example method 500 of service cluster update according to some example embodiments of the present disclosure. The method 500 may be implemented at the distributed network device 110 as shown in FIG. 1. For the purpose of discussion, the method 500 will be described with reference to FIG. 1.

At 510, the distributed network device 110 selects, from a set of candidate TRPs, one or more target TRPs associated with an update of a service cluster of a terminal device at least based on timing advances of the terminal device respect to the set of candidate TRPs.

At 520, the distributed network device 110 transmit information related to the update of a service cluster.

In some example embodiments, the distributed network device may further transmit to the terminal device and the set of candidate TRPs, an indication of an uplink resource allocation for the terminal device.

In some example embodiments, the distributed network device may further receive, from the set of candidate TRPs, information about timing advances of the terminal device respect to the set of candidate TRPs.

In some example embodiments, selecting the one or more target TRPs associated with the update of the service cluster comprises: in accordance with a determination that a timing advance of a first candidate TRP in the set of candidate TRPs satisfies a threshold timing advance, selecting the first candidate TRP as the one or more target TRPs.

In some example embodiments, in accordance with a determination that a timing advance of a second candidate TRP in the set of candidate TRPs does not satisfy a threshold timing advance; or in accordance with a determination that a timing advance of a second candidate TRP in the set of candidate TRPs satisfies a threshold timing advance and a radio link quality of the second candidate TRP does not satisfy a threshold quality level; or in accordance with a determination that a timing advance of a second candidate TRP in the subset of candidate TRPs satisfies a threshold timing advance and a load of the second candidate TRP does not satisfy a threshold load level, the distributed network device may further cause the second candidate TRP not to be selected as the one or more target TRPs.

In some example embodiments, the one or more target TRPs comprises at least one of one or more existing TRPs that are already existed in the service cluster, or one or more new TRPs new joined to the service cluster.

In some example embodiments, transmitting the information related to the update of a service cluster comprises transmitting, to the one or more target TRP, an activation command comprising at least one of the following: the RRC configuration of the one or more new TRPs, an indication of timing advance value for the service cluster, or an indication associated with informing an update a medium access control-control element from the one or more existing TRPs or the one or more new TRPs.

In some example embodiments, transmitting the information related to the update of a service cluster comprises transmitting, to an existing TRP selected from the one or more existing TRPs, information about at least one of: one or more new TRPs that require to join the service cluster, or one or more existing TRPs previously in the service cluster that require to quit from the service cluster.

In some example embodiments, transmitting the information related to the update of a service cluster comprises transmitting, to a TRP that requires changes, information about at least one of: an existing TRP selected from the one or more existing TRPs, one or more new TRPs that require to join the service cluster, or one or more existing TRPs previously in the service cluster that require to quit from the service cluster.

In some example embodiments, transmitting the information related to the update of a service cluster comprises transmitting, to a TRP that requires changes, a TRP modification request about at least one of: one or more new TRPs that require to join the service cluster, or one or more existing TRPs previously in the service cluster that require to quit from the service cluster.

In some example embodiments, the distributed network device may further receive a TRP modification response from the TRP that requires changes.

In some example embodiments, the distributed network device may further update information about TRPs in the service cluster of the terminal device after the update of the service cluster.

FIG. 6 shows a flowchart of an example method 600 of service cluster update according to some example embodiments of the present disclosure. The method 600 may be implemented at the TRP 120 as shown in FIG. 1. For the purpose of discussion, the method 600 will be described with reference to FIG. 1.

At 610, the TRP receives, from a distributed network node, information related to an update of a service cluster of a terminal device.

In some example embodiments, the one or more TRPs comprises at least one of one or more existing TRPs that are already existed in the service cluster, or one or more new TRPs new joined to the service cluster.

In some example embodiments, the information related to one or more TRPs comprises: an activation command comprising at least one of the following: the RRC configuration of the one or more new TRPs, at least one of: an indication of timing advance value for the service cluster, or an indication associated with informing an update a medium access control-control element from the one or more existing TRPs or the one or more new TRPs.

In some example embodiments, the TRP may further transmit, to the terminal device, an indication for activating the new TRP at the terminal device.

In some example embodiments, the TRP may further receive a TRP modification request acknowledge from the terminal device.

In some example embodiments, if the TRP comprises an existing TRP selected from the one or more existing TRPs, the information related to one or more TRPs comprises: one or more new TRPs that require to join the service cluster, or one or more existing TRPs previously in the service cluster that require to quit from the service cluster.

In some example embodiments, the TRP may further transmit a TRP modification request acknowledge to the one or more new TRPs; and receive a TRP modification response from the one or more new TRPs.

In some example embodiments, if the TRP comprises a TRP that requires changes, the information related to the one or more TRPs comprises at least one of: an existing TRP selected from the one or more existing TRPs, one or more new TRPs that require to join the service cluster, or one or more existing TRPs previously in the service cluster that require to quit from the service cluster.

In some example embodiments, the TRP that requires changes may further transmit a TRP modification request acknowledge to the existing TRP and receive a TRP modification response from the existing TRP.

In some example embodiments, if the TRP comprises a TRP that requires changes, the information related to the one or more TRPs comprises: a TRP modification request indicating at least one of: one or more new TRPs that require to join the service cluster, or one or more existing TRPs previously in the service cluster that require to quit from the service cluster.

In some example embodiments, the TRP that requires changes may further transmit a TRP modification response to the distributed network node.

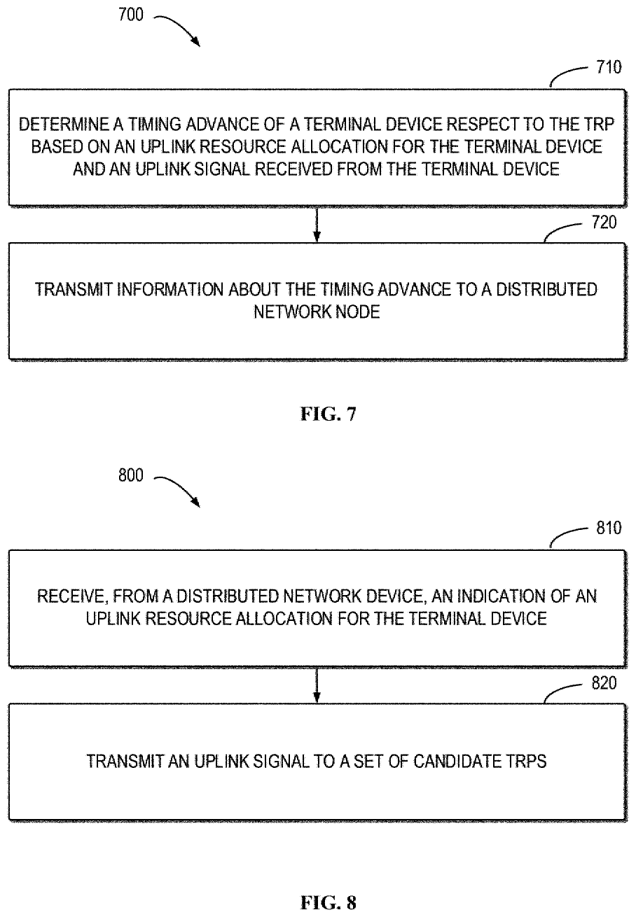

FIG. 7 shows a flowchart of an example method 700 of service cluster update according to some example embodiments of the present disclosure. The method 700 may be implemented at the TRP 120 as shown in FIG. 1. For the purpose of discussion, the method 700 will be described with reference to FIG. 1.

At 710, the TRP determines a timing advance of a terminal device respect to the TRP based on an uplink resource allocation for the terminal device and an uplink signal received from the terminal device.

At 720, the TRP transmits information about the timing advance to a distributed network node.

In some example embodiments, the uplink signal is received via at least one of a random access message, a sounding reference signal or a common uplink resource based on the uplink resource allocation.

FIG. 8 shows a flowchart of an example method 800 of service cluster update according to some example embodiments of the present disclosure. The method 800 may be implemented at the terminal device 130 as shown in FIG. 1. For the purpose of discussion, the method 800 will be described with reference to FIG. 1.

At 810, the terminal device receives, from a distributed network device, an indication of an uplink resource allocation for the terminal device.

At 820, the terminal device transmits an uplink signal to a set of candidate TRPs.

In some example embodiments, the uplink signal is transmitted via at least one of a random access message, a sounding reference signal or a common uplink resource based on the uplink resource allocation.

In some example embodiments, the terminal device 130 may further receive, from a new TRP joined associated with an update of a service cluster of the terminal device, an indication for activating the new TRP at the terminal device.

In some example embodiments, the indication further comprises a timing advance of the terminal device respect to the new TRP and a configuration of the new TRP.

In some example embodiments, the terminal device 130 may further transmit a TRP modification request acknowledge to the new TRP and/or an existing TRP that are already existed in the service cluster.

In some example embodiments, an apparatus capable of performing the method 500 (for example, implemented at the distributed network device 110) may include means for performing the respective steps of the method 500. The means may be implemented in any suitable form. For example, the means may be implemented in a circuitry or software module.

In some example embodiments, the apparatus comprises means for selecting, from a set of candidate TRPs, one or more target TRPs associated with an update of a service cluster of a terminal device at least based on timing advances of the terminal device respect to the set of candidate TRPs; and means for transmitting information related to the update of a service cluster.

In some example embodiments, an apparatus capable of performing the method 600 (for example, implemented at the TRP 120) may include means for performing the respective steps of the method 600. The means may be implemented in any suitable form. For example, the means may be implemented in a circuitry or software module.

In some example embodiments, the apparatus comprises means for receiving, from a distributed network node, information related to one or more apparatuses associated with an update of a service cluster of a terminal device.

In some example embodiments, an apparatus capable of performing the method 700 (for example, implemented at the TRP 120) may include means for performing the respective steps of the method 700. The means may be implemented in any suitable form. For example, the means may be implemented in a circuitry or software module.

In some example embodiments, the apparatus comprises means for determining a timing advance of a terminal device respect to the apparatus based on an uplink resource allocation for the terminal device and an uplink signal received from the terminal device; and means for transmitting information about the timing advance to a distributed network node.

In some example embodiments, an apparatus capable of performing the method 800 (for example, implemented at the terminal device 130) may include means for performing the respective steps of the method 800. The means may be implemented in any suitable form. For example, the means may be implemented in a circuitry or software module.

In some example embodiments, the apparatus comprises means for receiving, from a distributed network device, an indication of an uplink resource allocation for the apparatus; and means for transmitting an uplink signal to a set of candidate TRPs.

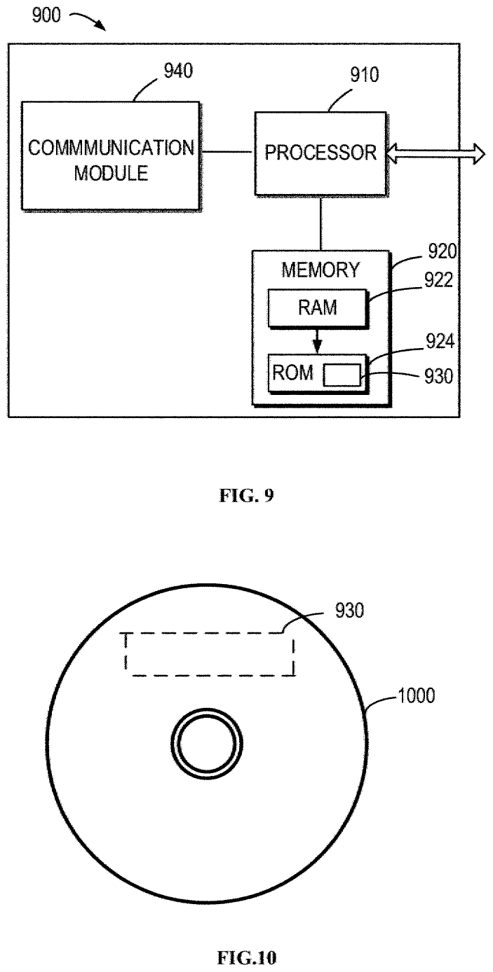

FIG. 9 is a simplified block diagram of a device 900 that is suitable for implementing example embodiments of the present disclosure. The device 900 may be provided to implement a communication device, for example, the distributed network device 110, the TRP 120 or the terminal device 130 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-39. (canceled)

40. A distributed network node comprising:
at least one processor; and
at least one memory storing instructions that, when executed by the at least one processor, cause the distributed network node at least to perform:
selecting, from a set of candidate transmission and reception points, TRPs, one or more target TRPs associated with an update of a service cluster of a terminal device at least based on timing advances of the terminal device respect to the set of candidate TRPs; and
transmitting information related to the update of a service cluster.

41. The distributed network node of claim 40, wherein the distributed network node is further caused to perform:
transmitting, to the terminal device and the set of candidate TRPs, an indication of an uplink resource allocation for the terminal device.

42. The distributed network node of claim 40, wherein the distributed network node is further caused to perform:
receiving, from the set of candidate TRPs, information about timing advances of the terminal device respect to the set of candidate TRPs.

43. The distributed network node of claim 40, wherein selecting the one or more target TRPs associated with the update of the service cluster comprises:
in accordance with a determination that a timing advance of a first candidate TRP in the set of candidate TRPs satisfies a threshold timing advance, selecting the first candidate TRP as the one or more target TRPs.

44. The distributed network node of claim 40, wherein the distributed network node is further caused to perform:
in accordance with a determination that a timing advance of a second candidate TRP in the set of candidate TRPs does not satisfy a threshold timing advance; or
in accordance with a determination that a timing advance of a second candidate TRP in the set of candidate TRPs satisfies a threshold timing advance and a radio link quality of the second candidate TRP does not satisfy a threshold quality level; or
in accordance with a determination that a timing advance of a second candidate TRP in the subset of candidate TRPs satisfies a threshold timing advance and a load of the second candidate TRP does not satisfy a threshold load level, causing the second candidate TRP not to be selected as the one or more target TRPs.

45. The distributed network node of claim 40, wherein the one or more target TRPs comprises at least one of:
one or more existing TRPs that are already existed in the service cluster, or
one or more new TRPs new joined to the service cluster.

46. The distributed network node of claim 45, wherein transmitting the information related to the update of a service cluster comprises:
transmitting, to the one or more target TRP, an activation command comprising at least one of the following:
the RRC configuration of the one or more new TRPs.
an indication of timing advance value for the service cluster, or
an indication associated with informing an update a medium access control-control element from the one or more existing TRPs or the one or more new TRPs.

47. The distributed network node of claim 45, wherein transmitting the information related to the update of a service cluster comprises:
transmitting, to an existing TRP selected from the one or more existing TRPs, information about at least one of:
one or more new TRPs that require to join the service cluster, or
one or more existing TRPs previously in the service cluster that require to quit from the service cluster.

48. The distributed network node of claim 45, wherein transmitting the information related to the update of a service cluster comprises:
transmitting, to a TRP that requires changes, information about at least one of:
an existing TRP selected from the one or more existing TRPs,
one or more new TRPs that require to join the service cluster, or
one or more existing TRPs previously in the service cluster that require to quit from the service cluster.

49. The distributed network node of claim 45, wherein transmitting the information related to the update of a service cluster comprises:
transmitting, to a TRP that requires changes, a TRP modification request about at least one of:
one or more new TRPs that require to join the service cluster, or
one or more existing TRPs previously in the service cluster that require to quit from the service cluster.

50. The distributed network node of claim 49, wherein the distributed network node is further to perform:
receiving a TRP modification response from the TRP that requires changes.

51. The distributed network node of claim 40, wherein the distributed network node is further to perform:
updating information about TRPs in the service cluster of the terminal device after the update of the service cluster.

52. A transmission and reception point, TRP, comprising:
at least one processor; and
at least one memory storing instructions that, when executed by the at least one processor, cause the TRP at least to perform:
receiving, from a distributed network node, information related to an update of a service cluster of a terminal device,
wherein the information comprises:
one or more new TRPs new joined to the service cluster,
wherein the information related to one or more new TRPs comprises:
an activation command comprising at least one of:
the RRC configuration of the one or more new TRPs, or
an indication of timing advance value for the service cluster,
wherein the TRP is further caused to perform:
transmitting, to the terminal device, an indication for activating at least one new TRP at the terminal device.

53. The TRP of claim 52, wherein the TRP is further caused to perform:
receiving a TRP modification request acknowledge from the terminal device.

54. The TRP of claim 52, wherein the TRP comprises an existing TRP selected from one or more existing TRPs, and wherein the information related to one or more TRPs comprises:
one or more new TRPs that require to join the service cluster, or
one or more existing TRPs previously in the service cluster that require to quit from the service cluster.

55. The TRP of claim 54, wherein the existing TRP is further caused to perform:
transmitting a TRP modification request acknowledge to the one or more new TRPs; and
receiving a TRP modification response from the one or more new TRPs.

56. The TRP of claim 52, wherein the TRP comprises a TRP that requires changes, and wherein the information related to the one or more TRPs comprises at least one of:
an existing TRP selected from the one or more existing TRPs,
one or more new TRPs that require to join the service cluster, or
one or more existing TRPs previously in the service cluster that require to quit from the service cluster.

57. The TRP of claim 56, wherein the TRP that requires changes is further caused to perform:
transmitting a TRP modification request acknowledge to the existing TRP; and
receiving a TRP modification response from the existing TRP.

58. The TRP of claim 52, wherein the TRP comprises a TRP that requires changes, and wherein the information related to the one or more TRPs comprises:
a TRP modification request indicating at least one of:
one or more new TRPs that require to join the service cluster, or
one or more existing TRPs previously in the service cluster that require to quit from the service cluster.

59. The TRP of claim 58, wherein the TRP that requires changes is further caused to perform:
transmitting a TRP modification response to the distributed network node.

60. A terminal device, comprising:
at least one processor; and
at least one memory storing instructions that, when executed by the at least one processor, cause the terminal device at least to perform:
receiving, from a distributed network device, an indication of an uplink resource allocation for the terminal device; and
transmitting an uplink signal to a set of candidate transmission and reception points, TRPs.

61. The terminal device of claim 60, wherein the uplink signal is transmitted via at least one of a random access message, a sounding reference signal or a common uplink resource based on the uplink resource allocation.

62. The terminal device of claim 60, wherein the terminal device is further caused to perform:
receiving, from a new TRP joined associated with an update of a service cluster of the terminal device, an indication for activating the new TRP at the terminal device.

63. The terminal device of claim 62, wherein the indication further comprises a timing advance of the terminal device respect to the new TRP and a configuration of the new TRP.

64. The terminal device of claim 62, wherein the terminal device is further caused to perform:
transmitting a TRP modification request acknowledge to the new TRP and/or an existing TRP that are already existed in the service cluster.
